(19) United States
(12) Patent Application Publication
(10) Pub. No.: US 2004/0003049 A1
(43) Pub. Date: Jan. 1, 2004

(54) Parallel computer and analysis method, and computer product

(75) Inventors: Katsuya Daigo, Nagasaki (JP); Hideo Fukuda, Nagasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Mitsubishi Heavy Industries, Ltd., Tokyo (JP)

(21) Appl. No.: 10/180,312

(22) Filed: Jun. 27, 2002

(51) Int. Cl. G06F 15/16

(52) U.S. Cl. 709/208

(57) ABSTRACT

Each slave device performs shifting to a receive standby status, performing analysis calculation of an own area, transmitting boundary data obtained from the calculation result to all slave devices which analyze the adjacent areas, receiving the boundary data from all the slave devices, performing again the analysis calculation of the own area using all the boundary data, repeatedly executing boundary data transaction and the analysis calculation until the boundary value of each area is settled, and transmitting notification information indicating termination of the analysis processing to a master device.

### FIELD OF THE INVENTION

The present invention relates to a parallel computer which performs thermal-hydraulic analysis of boilers or the like and navigation performance analysis of ships or the like, and to an analysis method thereof.

### BACKGROUND OF THE INVENTION

A conventional parallel computer will be first explained. For example, in order to promote differentiation of combustion appliances such as boilers, the thermal-hydraulic analysis has to be further upgraded, but if upgrading is promoted, the computing load increases. Specifically speaking, two to four weeks, for example, are necessary for the current combustion calculation using a workstation (DEC Alpha) for every one case. In order to shorten the period required for this calculation, upgrading of the computer is essential. However, since the high-performance computer becomes expensive, environmental improvement for a computer which is cheap and performs high-speed calculation is an urgent need.

Therefore, it is effective to construct a parallel computer by a PC cluster having high cost performance, but high parallelism is necessary in order to realize a high-speed computer, and development of a communication method supporting for the high parallelism is necessary to realize the high parallelism.

The operation of the high parallel computer formed of the conventional PC cluster will be described below. Conventionally, individual slave device activated by a computer which acts as a master device basically performs thermal-hydraulic analysis calculation for a predetermined area in a boiler assigned to the own device (area division method). With this method, a communication partner of the slave device is fixed to the master device, and the transfer order is also fixed. Therefore, deadlock does not occur. FIG. 13 is a flowchart which shows the conventional analysis method.

The master device transmits an initial value necessary to perform the thermal-hydraulic analysis to all the slave devices (step S101), and waits to receive a response from each of the slave devices, that is, boundary data of the area assigned to the slave device (being the input information of the slave device which performs the thermal-hydraulic analysis of an area adjacent to the area) (step S102).

When having received the boundary data from the first slave device (step S103, No), the master device waits to receive the boundary data from the remaining slave devices (step S102). When it is confirmed that the boundary data from all slave devices has been received (step S103, Yes), the master device rearranges the received boundary data (step S104), and then transmits the boundary data to all the slave devices (step S105).

Thereafter, until the thermal-hydraulic analysis using the boundary data is completed (step S106, No), the processing of from step S102 to step S105 is repetitively executed. When the boundary value of each area is settled and the analysis result is obtained to the master device (step S106, Yes), the processing in the master device is finished.

On the other hand, after having received the initial value from the master device (step S111), each slave device performs thermal-hydraulic analysis calculation with respect to the area assigned to the own device (step S112). Each slave device transmits the boundary data obtained from the calculation result (step S113), and receives the latest boundary data from the master device as a response thereto (step S114).

At this stage, each slave device confirms whether the boundary value of each area has been settled, and if not (step S115, No), repetitively executes the processing of from step S112 to step S114, until the boundary value of each area is settled. When the boundary value of each area has been settled (Step S115, Yes), the processing in the slave device is finished.

In the conventional parallel computer, however, there is a problem in that as the parallelism becomes high, that is, as the number of the slave devices increases, the transmission partners of the master device increase to increase the communication load of the master device, and hence a desired communication speed cannot be obtained.

Specifically speaking, the conventional parallel computer orchestrates the master device to control whole transfer of the boundary data, and therefore the waiting time of the slave device increases, and as a result, the desired communication speed cannot be obtained.

### SUMMARY OF THE INVENTION

It is an object of the present invention to provide a parallel computer that can realize high-speed analysis processing, without increasing the communication load of the master device, even when the number of the slave devices is increased to realize high parallelism.

The parallel computer according to one aspect of this invention comprises a master device and a plurality of slave devices, and performs predetermined analysis processing by adopting an area division method of dividing an area as an object for analysis into areas and assigning the areas to the slave devices, and by passing boundary data between the slave devices to which adjacent areas are assigned for analysis. The master device includes a unit for transmitting an initial value necessary to perform the analysis processing to all the slave devices, a unit for receiving notification information indicating termination of the analysis processing from all the slave devices, and a unit for controlling processing. Each of the slave devices includes a unit for receiving the initial value and shifting to a receive standby status in which the slave device waits for boundary data from other slave devices which analyze the adjacent areas, a unit for performing analysis calculation of the assigned own area, and a unit for transmitting the boundary data obtained from a result of the calculation to all the slave devices which analyze the adjacent areas. The slave device also includes a unit for receiving the boundary data from all the slave devices, performing again the analysis calculation of the own area using all the boundary data, and repetitively executing the boundary data passing and the analysis calculation until a boundary value of each area is settled. The slave device further includes a unit for transmitting the notification information indicating termination of the analysis processing to the master device when the boundary value of each area has been settled. The master device finishes all the processing when having received the notification from all the slave devices.

The parallel computer according to another aspect of this invention comprises a master device and a plurality of slave devices, and performs predetermined analysis processing by adopting an area division method of dividing an area as an object for analysis into areas and assigning the areas to the slave devices, and by passing boundary data between the slave devices to which adjacent areas are assigned for analysis. The master device includes a unit for transmitting an initial value necessary to perform the analysis processing to all the slave devices, a unit for receiving notification information indicating termination of the analysis processing from all the slave devices, and a unit for controlling processing. Each of the slave devices includes a unit for receiving the initial value and shifting to a receive standby status in which the slave device waits for the boundary data from other slave devices which analyze the adjacent areas, a plurality of CPUs for dividing the assigned area into areas to perform analysis calculation on the areas, and a unit for transmitting the boundary data obtained from a result of the calculation to all the slave devices which analyze the adjacent areas. The slave device also includes a unit for receiving the boundary data from all the slave devices which analyze the adjacent areas, performing the analysis calculation again using all the boundary data, and repetitively executing the boundary data passing and analysis calculation until a boundary value of each area is settled. The slave device further includes a unit for transmitting notification information indicating termination of the analysis processing to the master device when the boundary value of each area has been settled. The master device finishes all the processing when having received the notification from all the slave devices.

In the analysis method according to still another aspect of this invention, predetermined analysis processing is performed by adopting an area division method of dividing an area as an object for analysis into areas and assigning the areas to slave devices, and by passing boundary data between the slave devices to which adjacent areas are assigned for analysis. The method comprises steps of, as processing to be executed by a master device, transmitting an initial value necessary to perform the analysis processing to all the slave devices, and receiving notification information indicating termination of the analysis processing from all the slave devices. The method also comprises steps of, as the processing to be executed by the respective slave devices, shifting to a receive standby status in which the slave device waits for boundary data from other slave devices which analyze the adjacent areas, performing analysis calculation of the assigned own area, and transmitting the boundary data obtained from a result of the calculation to all the slave devices which analyze the adjacent areas. The method further comprises steps of, as the processing to be executed by the respective slave devices, receiving the boundary data from all the slave devices which analyze the adjacent areas, performing again the analysis calculation of the own area using all the boundary data, and repetitively executing the boundary data passing and the analysis calculation until a boundary value of each area is settled. The method further comprises a step of, as the processing to be executed by the respective slave devices, transmitting the notification information indicating the termination of the analysis processing to the master device when the boundary value of each area has been settled.

In the analysis method according to still another aspect of this invention, predetermined analysis processing is performed by adopting an area division method of dividing an area as an object for analysis into areas and assigning the areas to slave devices, and by passing boundary data between the slave devices to which adjacent areas are assigned for analysis. The method comprises steps of, as processing to be executed by a master device, transmitting an initial value necessary to perform the analysis processing to all the slave devices, and receiving notification information indicating termination of the analysis processing from all the slave devices. The analysis method also comprises steps of, as processing to be executed by the respective slave devices, shifting to a receive standby status in which the slave device waits for boundary data from other slave devices which analyze the adjacent areas, dividing the assigned area into areas to perform analysis calculation on the areas by a plurality of CPUs in the slave device divide, and transmitting the boundary data obtained from a calculation result to all the slave devices which analyze the adjacent areas. The method further comprises steps of, as the processing to be executed by the respective slave devices, receiving the boundary data from all the slave devices which analyze the adjacent areas, performing again the analysis calculation of the assigned own area using all the boundary data, and repetitively executing the boundary data passing and the analysis calculation until the boundary value of each area is settled. The method further comprises a step of, as the processing to be executed by the respective slave devices, transmitting the notification information indicating the termination of the analysis processing to the master device when the boundary value of each area has been settled.

The computer program for analysis to be executed by slave devices according to still another aspect of this invention, comprises steps of shifting to a receive standby status in which the slave device waits for boundary data from other slave devices which analyze areas adjacent to each other, performing analysis calculation of an own area, and transmitting boundary data obtained from a calculation result to all the slave devices which analyze the adjacent areas. The program also comprises steps of receiving the boundary data from all the slave devices which analyze the adjacent areas, performing again the analysis calculation of the own area using all the boundary data, and repetitively executing boundary data passing and the analysis calculation until a boundary value of each area is settled. The program further comprises a step of transmitting notification information indicating termination of the analysis processing to a master device when the boundary value of each area has been settled.

Other objects and features of this invention will become apparent from the following description with reference to the accompanying drawings.

### BRIEF DESCRIPTION OF THE DRAWINGS

FIG. 1 is a diagram which shows the configuration of the parallel computer according to the present invention,

FIG. 2 is a diagram which shows the configuration of a boiler, which is the object of thermal-hydraulic analysis performed by using the parallel computer,

FIG. 3 is a flowchart which shows a thermal-hydraulic analysis method in a first embodiment,

FIG. 4 is a diagram which expresses the operation of a thermal-hydraulic analysis processing chronologically,

FIG. 5 is a diagram which shows the comparison result of a conventional parallel computer and the parallel computer in the first embodiment,

FIG. 6 is a diagram which shows the configuration of an ordinary computer that can realize a thermal-hydraulic analysis,

FIG. 7 is a diagram which shows an example of performing a surrounding flow calculation of a ship which is moving straight,

FIG. 8 is a diagram which shows an example of performing a calculation of both sides of a ship which is moving obliquely or turning,

FIG. 9 is a flowchart which shows a thermal-hydraulic analysis method in a second embodiment,

FIG. 10A is a flowchart which shows a thermal-hydraulic analysis method in a third embodiment, and FIG. 10B is a diagram which shows an example of a computer list and an execution list,

FIG. 11 is a diagram which shows the configuration of a fourth embodiment,

FIG. 12 is a flowchart which shows a thermal-hydraulic analysis method in the fourth embodiment, and

FIG. 13 is a flowchart which shows the conventional analysis method.

### DETAILED DESCRIPTION

Embodiments of the present invention will now be explained in detail, with reference to the accompanying drawings. However, this invention is not limited by the embodiments.

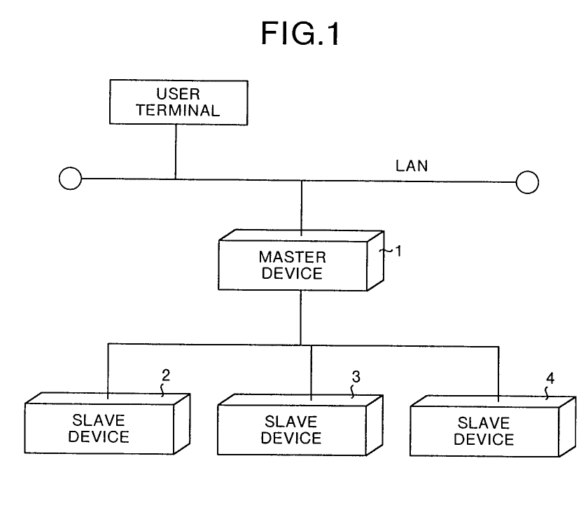

A first embodiment of this invention will be explained below. FIG. 1 is a diagram which shows the configuration of the parallel computer (PC cluster) according to the present invention. In FIG. 1, reference numeral 1 denotes a master device, and 2, 3 and 4 denote slave devices. The operation of the parallel computer according to this invention is different from the conventional operation, that is, the boundary data is transferred not under the control of the master device, but under the control between the slave devices. The number of the slave devices is set three herein for the sake of simplicity of explanation, but this number is variable depending on the number of areas of the boiler, being the object of the thermal-hydraulic analysis.

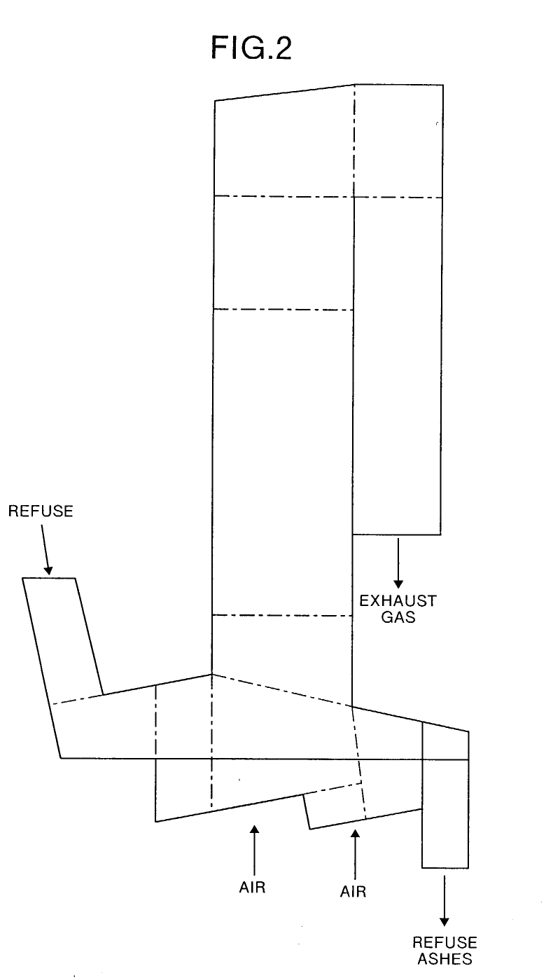

FIG. 2 is a diagram which shows the configuration of a refuse incineration boiler, which is the object of the thermal-hydraulic analysis performed by using the parallel computer according to the present invention. Here, the boiler is divided as shown by the chain lines in the figure, and a slave device is assigned to each area, respectively, and each slave device performs the thermal-hydraulic analysis of the area assigned to the own device.

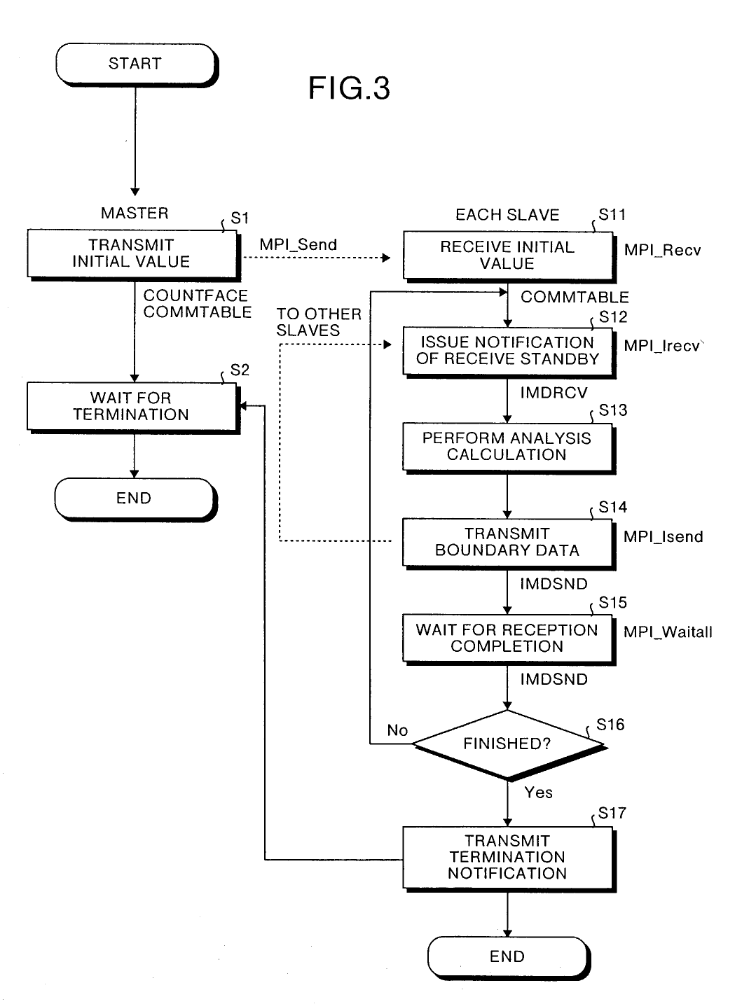

The operation of the master device and the slave device in the parallel computer according to the present invention will now be explained with reference to the drawings. FIG. 3 is a flowchart which shows the operation of the master device and the slave device, that is, the thermal-hydraulic analysis method.

The master device transmits an initial value necessary to perform the thermal-hydraulic analysis to all slave devices (step S1), and waits for a response from each of the slave devices, that is, notification information indicating termination of the thermal-hydraulic analysis (step S2). When having received the notification, the master device finishes the processing as the master device.

On the other hand, after having received the initial value from the master device (step S11), the slave device specifies a sender (a slave device which analyzes the adjacent area), and issues a notification that the slave device is in a receive standby status for the number of communication partners (step S12). Thereafter, the slave device performs the thermal-hydraulic analysis calculation with respect to the area assigned to the own device (step S13). The slave device then transmits the boundary data obtained from the calculation result to all the slave devices which analyze the adjacent areas (step S14). The slave device then confirms whether the boundary data for the adjacent areas has been received from all the slave devices, and if not, waits until the slave device receives the data (step S15). In the thermal-hydraulic analysis calculation, the boundary data transferred between respective slave devices is parameters of temperature, pressure, flow velocity and the like.

Thereafter, the slave device receives the boundary data from all the slave devices which analyze the adjacent areas (step S16, No), and executes the processing of from step S12 to step S15 again, using all the received boundary data (parameters).

At this stage, each slave device confirms whether the boundary value of each area has been settled (step S16), and if not (step S16, No), repetitively executes the processing of from step S12 to step S15 until the boundary value of each area has been settled. When the boundary value of each area has been settled (step S16, Yes), the slave device transmits a notification information indicating the termination of the thermal-hydraulic analysis to the master device (step S17), and finishes the processing in the slave device.

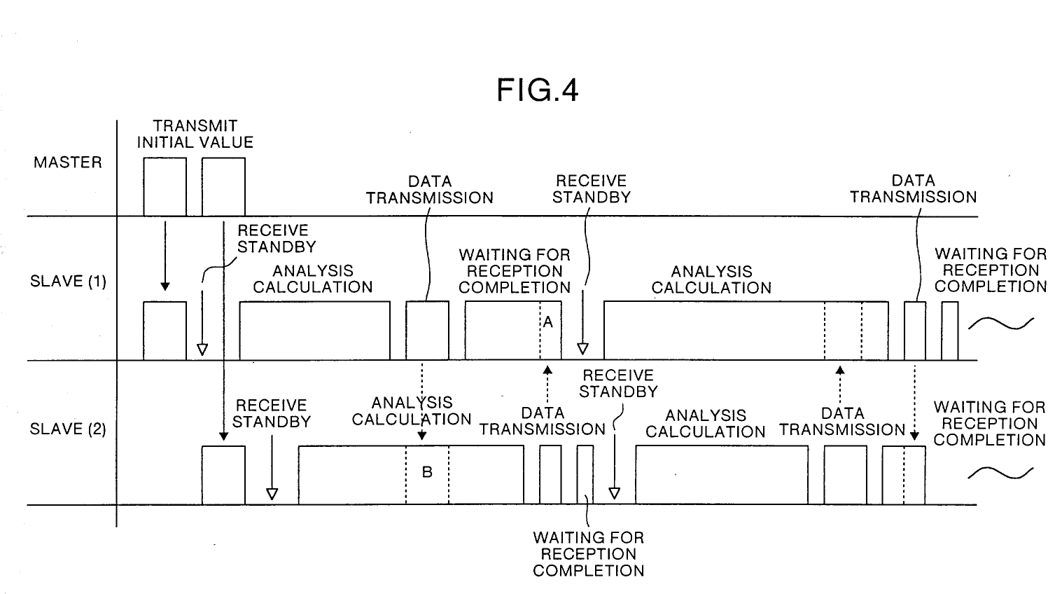

FIG. 4 is a diagram which expresses the operation of the flowchart chronologically. Here, an example in which the number of the slave devices is two is explained, for the sake of simplicity of explanation. At first, the master device transmits the initial value necessary to perform the thermal-hydraulic analysis to slave devices (1) and (2).

After having received the initial value from the master device, the slave device (1) specifies the slave device (2) which analyzes the adjacent area, and issues a notification that the slave device (1) is in a receive standby status. Thereafter, the slave device (1) performs the thermal-hydraulic analysis calculation with respect to the area assigned to the own device, and transmits the boundary data obtained from the calculation result to the slave device (2) which analyzes the adjacent area. The slave device (1) then continuously confirms whether the boundary data for the adjacent area has been received from the slave device (2) as the operation of waiting for reception completion, and receives the boundary data at a position A shown in the figure.

Thereafter, the slave device (1) having received the boundary data from the slave device (2) issues again the notification that the slave device (1) is in a receive standby status in the same manner and executes the thermal-hydraulic analysis calculation processing, using all the received boundary data. Hereinafter, the slave device 1 repetitively executes the processing shown in FIG. 3, and when the boundary value of each area is settled, transmits notification information indicating termination of the thermal-hydraulic analysis to the master device.

On the other hand, after having received the initial value from the master device, the slave device (2) specifies the slave device (1) which analyzes the adjacent area, and issues a notification that the slave device (2) is in a receive standby status. Thereafter, the slave device (2) performs the thermal-hydraulic analysis calculation with respect to the area assigned to the own device, and transmits the boundary data obtained from the calculation result to the slave device (1) which analyzes the adjacent area. The slave device (2) then confirms whether the boundary data for the adjacent area has been received from the slave device (1) as the operation of waiting for reception completion. Here, since the slave device (2) has already received the boundary data at a position B shown in the figure, the slave device (2) finishes the operation of waiting for reception completion immediately.

Thereafter, the slave device (2) issues a notification of receive standby in the same manner as described above, and executes the thermal-hydraulic analysis calculation processing, using all the received boundary data. Hereinafter, the slave device (2) repetitively executes the processing shown in FIG. 3, and when the boundary value of each area has been settled, transmits notification information indicating completion of the thermal-hydraulic analysis to the master device.

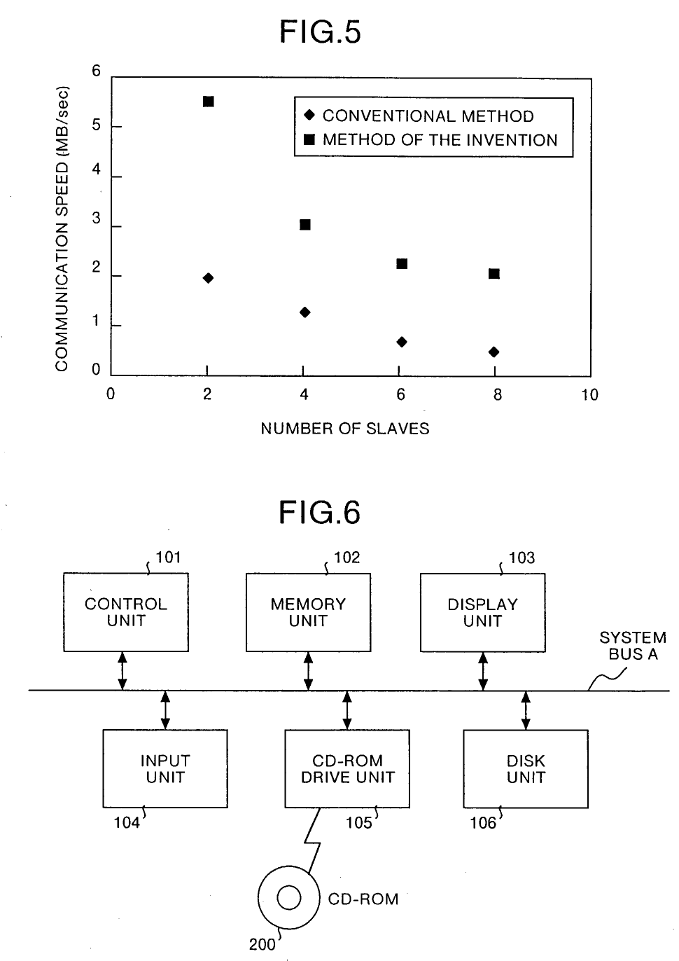

FIG. 5 is a diagram which shows the comparison result of the conventional parallel computer and the parallel computer of the present invention. As seen from FIG. 5, when the thermal-hydraulic analysis calculation is carried out by the above-described operation, the communication speed is improved than the calculation result by the conventional parallel computer. In the parallel computer of the present invention, boundary data is transferred between the slave devices, different from the conventional parallel computer, the waiting time of the slave device is reduced, thereby a desired communication speed can be obtained.

FIG. 6 is a diagram which shows the configuration of an ordinary computer which operates as a slave device shown in the above embodiment and can realize the thermal-hydraulic analysis.

This computer comprises a control unit 101 including a CPU, a memory unit 102, a display unit 103, an input unit 104, a CD-ROM drive unit 105, and a disk unit 106, wherein these respective units are connected via a system bus A, respectively. In FIG. 6, the control unit 101 executes the thermal-hydraulic analysis calculation processing of the above-described boiler or the like. The memory unit 102 includes a memory such as RAM and ROM, and stores a program to be executed by the control unit 101 and necessary data obtained in the course of processing. The display unit 103 is constituted of a CRT, a liquid crystald is play panel (LCD) or the like, and displays various screens with respect to the user of the computer system. The input unit 104 is constituted of a keyboard, a mouse and the like, and is used by the user of the computer to input various information. A program describing the processing shown on the right side (slave device) in FIG. 3 is stored in the CD-ROM 200 shown in FIG. 6.

In the computer constructed as described above, the program is installed in the disk unit 106 from the CD-ROM 200 set in the CD-ROM drive unit 105. When the computer is started up, the program is read out from the disk unit 106 and is stored in the memory unit 102. In this state, the control unit 101 (CPU) executes the processing shown in FIG. 3, in accordance with the program stored in the memory unit 102.

In the present invention, the program describing each processing is provided by the CD-ROM 200, but the recording medium of this program is not limited thereto, and other recording medium, for example, a magnetic disk such as a floppy disk, a magneto-optic disk, a magnetic tape, or ROM and RAM in a computer may be used according to a computer forming the system. The program recorded on the above recording medium is applicable to all slave devices.

As described above, the first embodiment has the configuration such that the boundary data is transferred between the slave devices, not through the master device, that is, each slave device performs the thermal-hydraulic analysis with respect to the area assigned to the own device, and directly transmits the boundary data obtained from the calculation result to all the slave devices which analyze the adjacent areas. Hence, even when the number of the slave devices is increased to realize high parallelism, high-speed analysis processing can be realized without increasing the communication load on the master device.

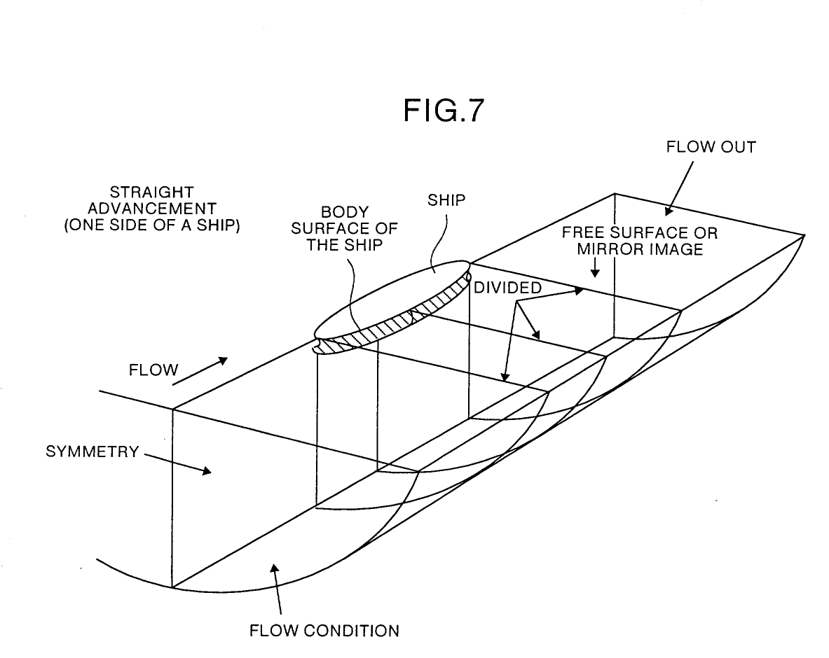

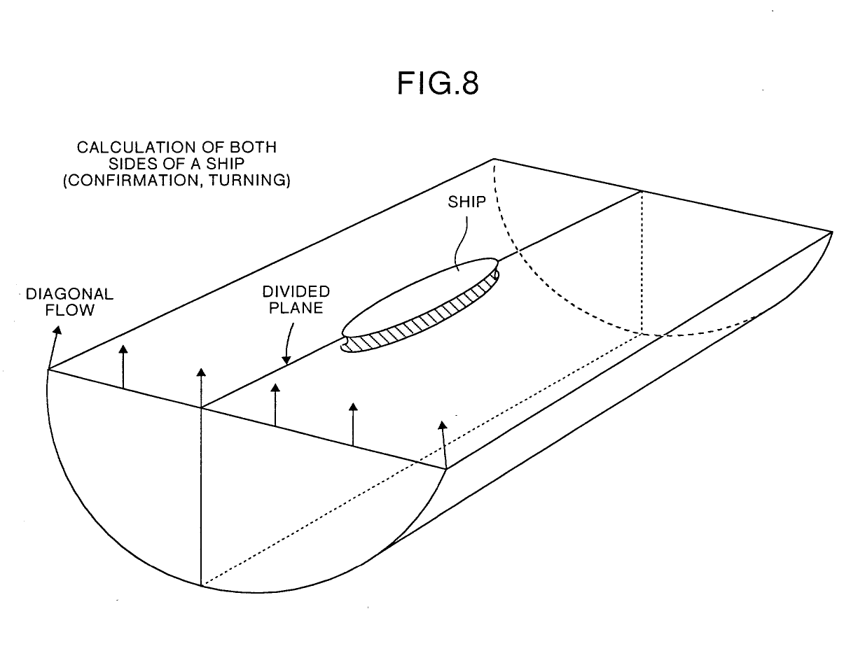

In the first embodiment, the parallel computer which executes the thermal-hydraulic analysis calculation processing of the refuse incineration boiler has been explained, but the parallel computer in this embodiment is not limited to the above processing, and is effective for all kinds of analysis processing using the area division method, and for example, it is also possible to perform a navigation performance analysis of ships. For example, FIG. 7 is a diagram which shows an example of performing a surrounding flow calculation of a ship which is moving straight, and FIG. 8 is a diagram which shows an example of performing a calculation of both sides of a ship which is moving obliquely or turning.

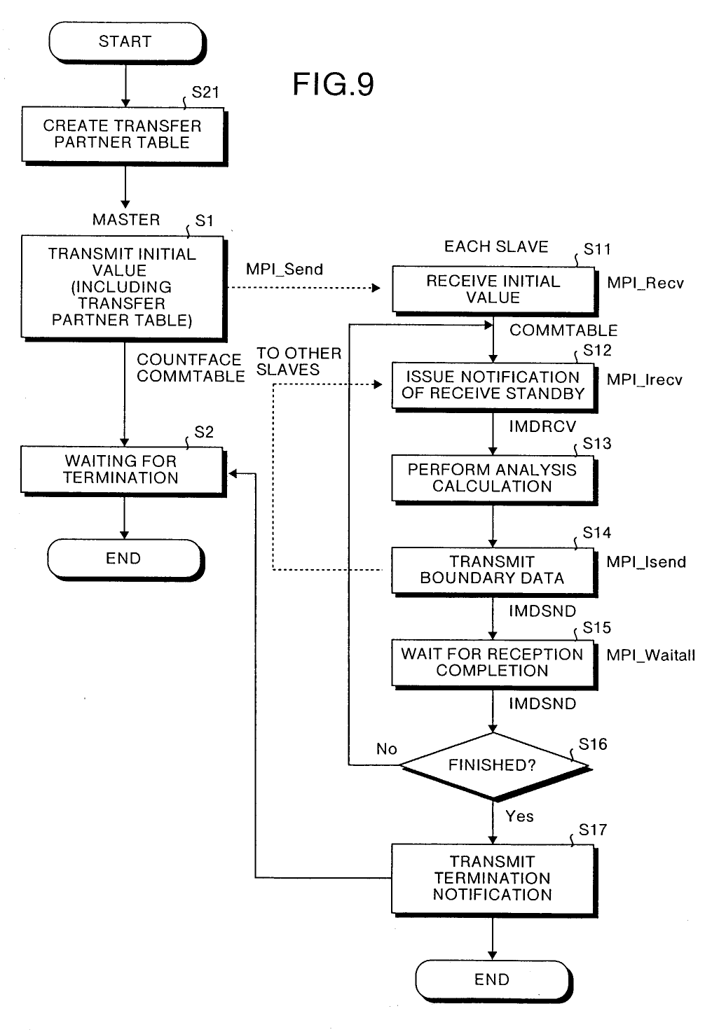

A second embodiment of this invention will be explained below. FIG. 9 is a flow chart which shows a thermal-hydraulic analysis method in the second embodiment. The explanation for the configuration similar to that of the first embodiment is omitted. Only the part different from that of the first embodiment will be explained herein.

The operation of the master device and the slave device in the parallel computer of the second embodiment will be explained with reference to FIG. 9.

At the time of initial setting, the master device creates a transfer partner table necessary for slave devices to directly specify respective communication partners and perform communications (step S21), transmits an initial value including the transfer partner table to all the slave devices (step S1), and waits for a response from the slave devices, that is, notification information indicating the termination of the thermal-hydraulic analysis (step S2). When having received the notification, the master device finishes the processing as the master device.

On the other hand, after having received the initial value from the master device (step S11), the slave device specifies a slave device which analyzes the adjacent area, and issues a notification that the slave device is in a receive standby status for the number of communication partners (step S12). Thereafter, the slave device performs the thermal-hydraulic analysis calculation with respect to the area assigned to the own device (step S13). The slave device then transmits the boundary data obtained from the calculation result to all the slave devices which analyze the adjacent areas (step S14), based on the transfer partner table. The slave device then confirms whether the boundary data for the adjacent area has been received from all the slave devices which analyze the adjacent areas (step S15). The operation hereinafter is the same as in the first embodiment.

As described above, in the second embodiment, effects similar to that of the first embodiment can be obtained. Further, since the configuration is such that the boundary data obtained from the thermal-hydraulic analysis calculation result is transferred between the slave devices based on the transfer partner table, the calculation processing in the slave device can be reduced. In the second embodiment, the parallel computer which executes the thermal-hydraulic analysis calculation processing for boilers or the like has been explained. However, the parallel computer in the second embodiment is not limited to the above processing, and is also effective for all kinds of analysis processing using the area division method, and for example, it is also possible to perform a navigation performance analysis of ships (similar to the first embodiment).

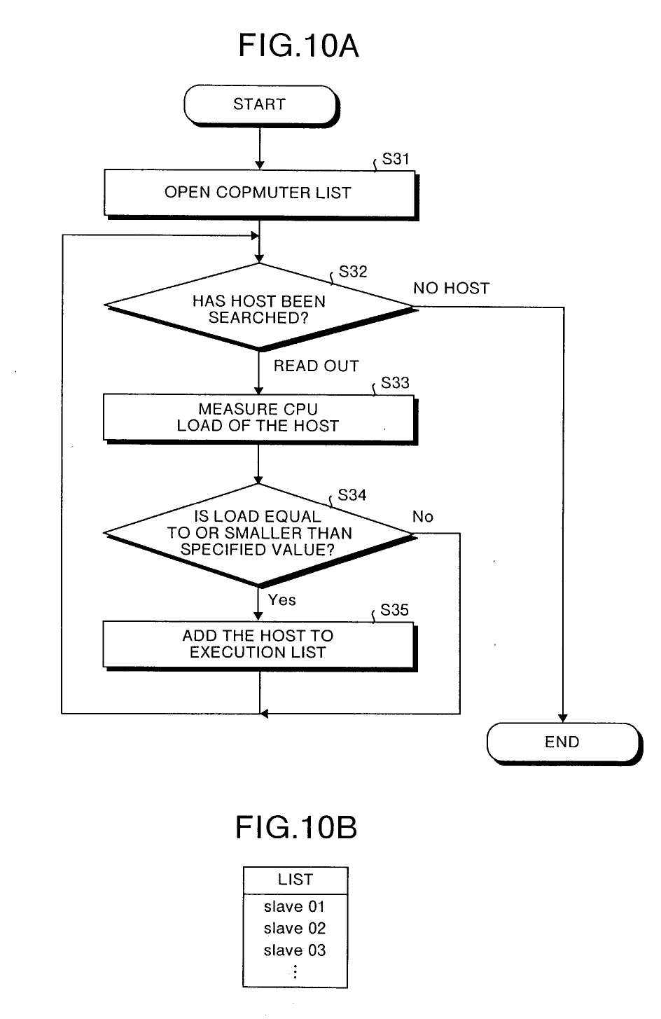

A third embodiment of this invention will be explained below. FIG. 10A is a flowchart which shows a thermal-hydraulic analysis method in the third embodiment. The same configuration as that of the first embodiment is not explained here. The processing in the third embodiment is applicable to the processing in the first and second embodiments, that is, to the processing shown in FIG. 3 and FIG. 9. Only the part different from that of the first and second embodiments will be explained herein.

The operation of the master device and the slave device in the parallel computer of the third embodiment will be explained below with reference to FIG. 10A. FIG. 10A is a diagram which shows a CPU allocation flow at the time of executing the thermal-hydraulic analysis, and FIG. 10B is a diagram which shows one example of the computer list and the execution list.

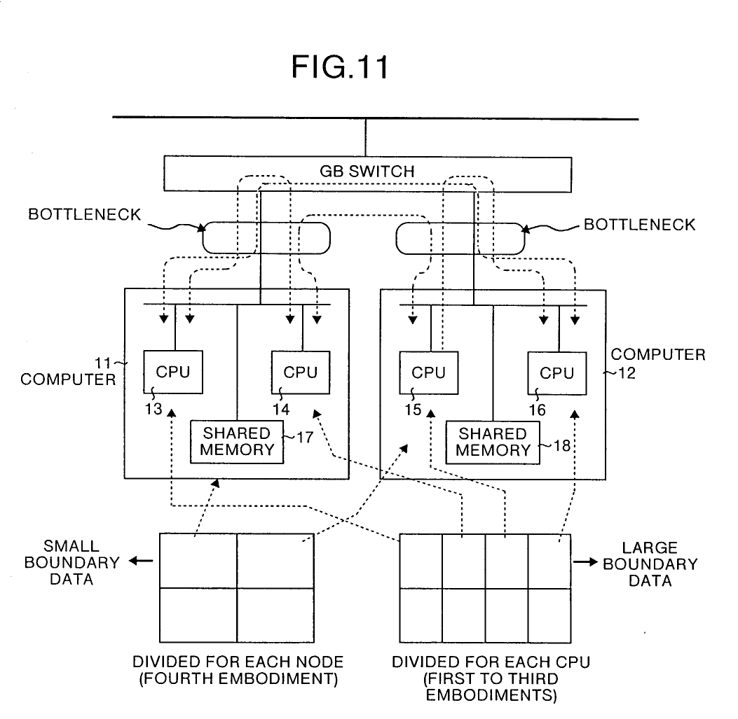

The parallel computer of the third embodiment executes processing shown in FIG. 11A before executing the program shown in FIG. 3 or FIG. 9 described above. At first, the master device opens the computer list enumerating host names of the computer, as shown in FIG. 10B (step S31), and searches an adequate host among these (step S32). If there is no host remaining in the computer list (step S32, No host), the execution list preparation processing is finished. On the other hand, if there is a remaining host (step S32, Readout), the master device reads out the host name, to measure the load of the CPU (step S33).

As a result, when the obtained load is smaller than a predetermined value provided in advance (step S34, Yes), the master device determines that the host is unoccupied, and adds the host name to the execution list. The processing of from step S32 to step S35 is repetitively executed until no host remains in the list.

On the other hand, when the obtained load is larger than the predetermined value (step S34, No), the master device determines that the host is being used by another user, and repetitively executes the processing of from step S32 to step S35 until the necessary number of CPUs can be secured.

Hereinafter, in the third embodiment, the parallel computer of this invention executes the program shown in FIG. 3 or FIG. 9 using the execution list, prepared in the above manner, in which the hosts available for the analysis processing are described.

As described above, in the third embodiment, the similar effect to that of the first or second embodiment can be obtained. Further, since the configuration is such that at the time of startup of the thermal-hydraulic analysis calculation processing, the available CPU is searched to secure the necessary number of CPUs, a plurality of users can use the same parallel computer at the same time, and the operating ratio of the CPU can be further improved. From the same reason, the CPU having a failure can be excluded in advance, and hence the trouble resistance can be considerably improved. In the third embodiment, the parallel computer which executes the thermal-hydraulic analysis calculation processing for boilers or the like has been explained. However, the parallel computer in the third embodiment is not limited to the above processing, and is also effective for all kinds of analysis processing using the area division method, and for example, it is also possible to perform a navigation performance analysis of ships (similar to the first embodiment).

A fourth embodiment of this invention will be explained below. FIG. 11 is a diagram which shows the configuration in the fourth embodiment. In FIG. 11, reference numerals 11 and 12 denote computers (slave devices), 13, 14, 15 and 16 denote CPUs, and 17 and 18 denote shared memories. A gigabit (GB) switch is used to connect between computers (CPUs) which perform communications in a predetermined speed However, the switch is not limited to this GB switch. The whole configuration in the fourth embodiment is the same as that shown in FIG. 1 in the first embodiment.

In the first through third embodiments, parallel execution by multiprocessing is performed, that is, one CPU in the computer performs the thermal-hydraulic calculation processing of one area (see lower right in FIG. 11). This method is excellent in general versatility since each processing is performed in an individual address space. In a distributed memory method, being a basic form of the PC cluster, each CPU executes processing based on separate OS, that is, in an individual address space, and therefore each processing is inevitably executed in parallel by multiprocessing. However, when parallel processing is executed by such multiprocessing, a bottleneck might arise during data transaction as shown in the upper side of FIG. 11.

Therefore, in the fourth embodiment, as shown in the lower left of FIG. 11, there is one process in the shared memory, and parallel execution is performed by multi-thread. That is, a computer having two CPUs and a shared memory performs the thermal-hydraulic calculation processing of the adjacent two areas. In this case, the thread group in the same process is executed in the same address space, and hence it is necessary to use the shared memory.

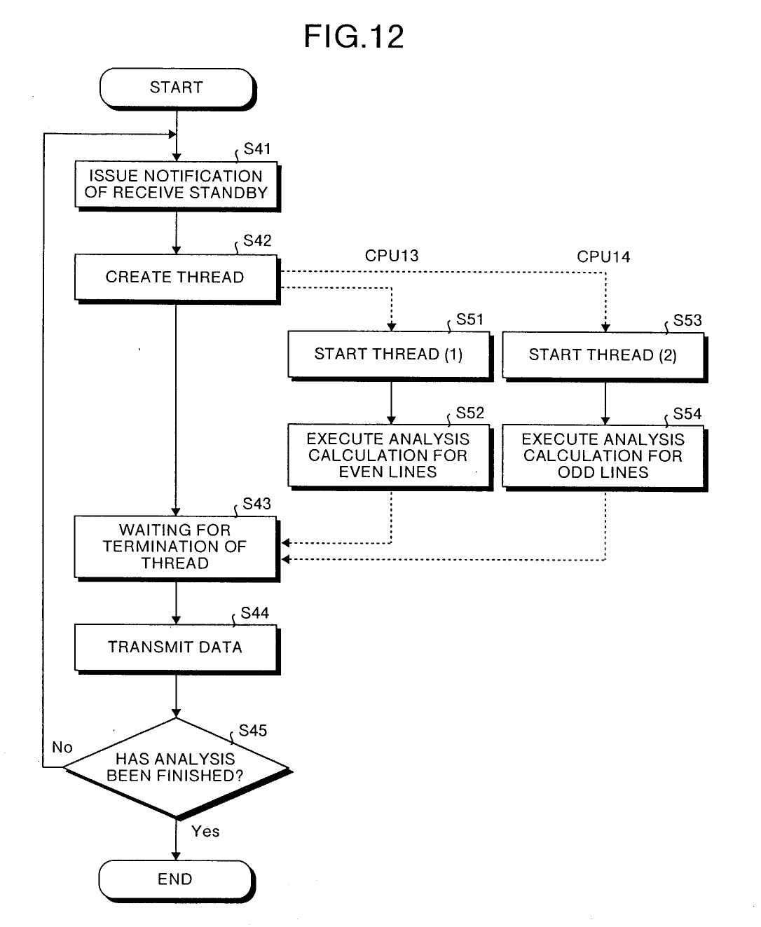

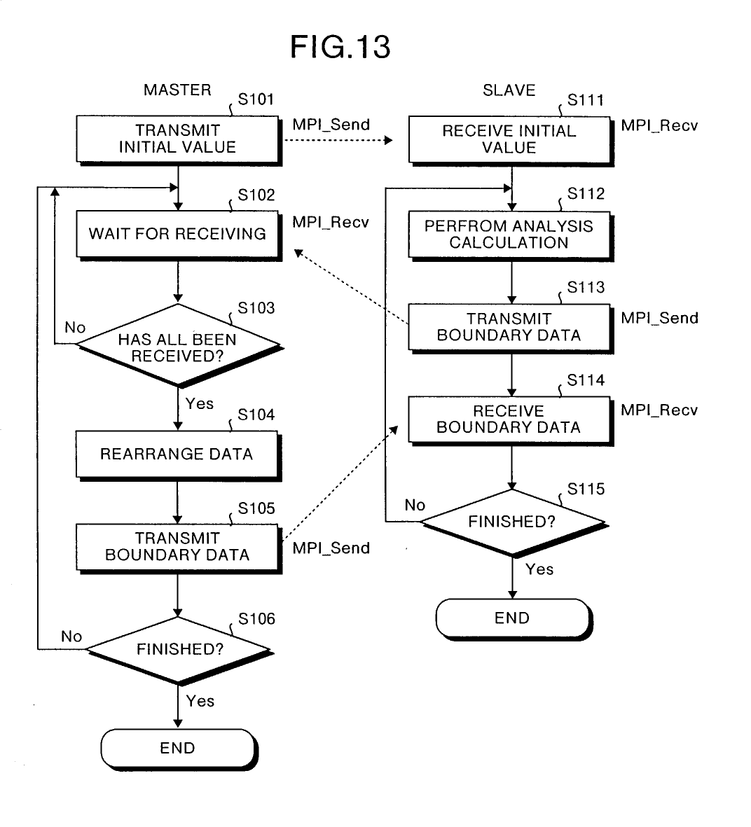

FIG. 12 is a flowchart which shows a thermal-hydraulic analysis method in the fourth embodiment. The operation of the slave device in the parallel computer according to the present invention will be explained below with reference to FIG. 12. The operation of the master device is the same as that in the first, second or third embodiment.

Each slave device issues a notification that it is in a receive standby status for the number of communication partners (step S41), and prepares a thread with respect to the area assigned to the own device. That is, the slave device performs the thermal-hydraulic analysis calculation with respect to the area assigned to the own device (step S42). Specifically speaking, the CPU 13 starts a thread (1) (step S51), to perform the thermal-hydraulic analysis calculation for the even lines in a predetermined area (step S52). The CPU 14 also starts a thread (2) (step S53), to perform the thermal-hydraulic analysis calculation for the odd lines in the predetermined area (step S54).

After having finished each thread (step S43), the slave device transmits the boundary data obtained from the calculation result to all the slave devices which analyze the adjacent areas (step S44), and confirms whether the boundary data for the adjacent areas has been received from all the slave devices which analyze the adjacent areas. If the boundary data has not been received, the slave device waits until it receives the data.

Thereafter, the slave device receives the boundary data from all the slave devices which analyze the adjacent areas (step S45, No), and executes the processing of from step S41 to step S44 again, using all the received boundary data.

At this stage, each slave device confirms whether the boundary value of each area has been settled (step S45), and if not (step S45, No), repetitively executes the processing of from step S41 to step S44 until the boundary value of each area is settled. When the boundary value of each area has been settled (step S45, Yes), the slave device transmits notification information indicating termination of the thermal-hydraulic analysis to the master device, to thereby finish the processing in the slave device.

As described above, in the fourth embodiment, the configuration is such that the computer having two CPUs and the shared memory performs the thermal-hydraulic calculation processing by sharing the area. Hence, communication between CPUs in the same computer is not necessary, thereby enabling reduction of the overhead than the first through third embodiments, and as a result, the performance can be improved. In the fourth embodiment, the parallel computer which executes the thermal-hydraulic analysis calculation processing for boilers or the like has been explained. However, the parallel computer in the fourth embodiment is not limited to the above processing, and is also effective for all kinds of analysis processing using the area division method, for example, it is also possible to perform a navigation performance analysis of ships (similar to the first embodiment).

As described above, according to the parallel computer as one aspect of this invention, the boundary data can be passed between the slave devices not through the master device. Specifically speaking, each slave device performs analysis calculation with respect to the area assigned to the own device, and directly transmits the boundary data obtained from the calculation result to all the slave devices which analyze the adjacent areas. As a result, it is advantageously possible to obtain the parallel computer capable of realizing high-speed analysis processing without increasing the communication load on the master device even when the number of the slave devices is increased to realize high parallelism.

Moreover, the boundary data obtained from the analysis calculation result is passed between the slave devices based on the transfer partner table. As a result, it is advantageously possible to obtain the parallel computer capable of reducing the calculation processing in the slave device.

Furthermore, at the time of startup of the analysis calculation processing, an available CPU is searched to secure the necessary number of CPUs. As a result, it is advantageously possible to obtain the parallel computer capable of improving the operating ratio of the CPU. Further, since the CPU having a failure can be excluded beforehand, it is advantageous lypossible to obtain the parallel computer capable of considerably improving the trouble resistance.

According to the parallel computer as another aspect of this invention, a computer having a shared memory with a plurality of CPUs performs the calculation processing by sharing the area. Thereby, communication between the CPUs within the same computer is not necessary and therefore the overhead can be reduced. As a result, it is advantageously possible to obtain the parallel computer capable of improving the performance.

According to the analysis method as still another aspect of this invention, the boundary data is passed between the slave devices not through the master device. Specifically speaking, each slave device performs analysis calculation with respect to the area assigned to the own device, and directly transmits the boundary data obtained from the calculation result to all the slave devices which analyze the adjacent areas. As a result, it is advantageously possible to obtain the parallel computer capable of realizing high-speed analysis processing without increasing the communication load on the master device even when the number of the slave devices is increased to realize high parallelism.

Moreover, the boundary data obtained from the analysis calculation result is passed between the slave devices based on the transfer partner table. As a result, it is advantageously possible to reduce the calculation processing in the slave device.

Furthermore, at the time of startup of the analysis calculation processing, an available CPU is searched to secure the necessary number of CPUs. As a result, it is advantageously possible to improve the operating ratio of the CPU. Further, since the CPU having a failure can be excluded beforehand, it is advantageously possible to considerably improve the trouble resistance.

According to the analysis method as still another aspect of this invention, a computer (slave device) having a shared memory with a plurality of CPUs performs the calculation processing by sharing the area. Thereby, communication between the CPUs within the same computer is not necessary and therefore the overhead can be reduced. As a result, it is advantageously possible to improve the performance.

According to the recording medium as still another aspect of this invention, the boundary data is passed between the slave devices not through the master device. Specifically speaking, each slave device performs analysis calculation with respect to the area assigned to the own device, and directly transmits the boundary data obtained from the calculation result to all the slave devices which analyze the adjacent areas. As a result, it is advantageously possible to obtain the program capable of realizing high-speed analysis processing without increasing the communication load on the master device even when the number of the slave devices is increased to realize high parallelism.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A parallel computer which comprises a master device and a plurality of slave devices, and performs predetermined analysis processing by adopting an area division method of dividing an area as an object for analysis into areas and assigning the areas to the slave devices, and by passing boundary data between the slave devices to which adjacent areas are assigned for analysis,
the master device including
a unit for transmitting an initial value necessary to perform the analysis processing to all the slave devices;
a unit for receiving notification information indicating termination of the analysis processing from all the slave devices; and
a unit for controlling processing, and
each of the slave devices including
a unit for receiving the initial value and shifting to a receive standby status in which the slave device waits for boundary data from other slave devices which analyze the adjacent areas;
a unit for performing analysis calculation of the assigned own area;
a unit for transmitting the boundary data obtained from a result of the calculation to all the slave devices which analyze the adjacent areas;
a unit for receiving the boundary data from all the slave devices, performing again the analysis calculation of the own area using all the boundary data, and repetitively executing the boundary data passing and the analysis calculation until a boundary value of each area is settled; and
a unit for transmitting the notification information indicating termination of the analysis processing to the master device when the boundary value of each area has been settled, wherein
the master device finishes all the processing when having received the notification from all the slave devices.

2. The parallel computer according to claim 1, wherein
the master device creates a transfer partner table, at the time of initial setting, which is used when each of the slave devices directly specifies a communication partner and transfers the boundary data to each other, and transmits the initial value including the table to all the slave devices, and
the slave device transmits the boundary data obtained from the calculation result to all the slave devices which analyze the adjacent areas, based on the table.

3. The parallel computer according to claim 1, wherein
the master device measures load of a CPU in each slave device before transmitting the initial value, determines that the analysis processing is possible when a result of the measurement is smaller than a predetermined value provided in advance, determines that the CPU is being used by another user when the measurement result is larger than the predetermined value, and repetitively executes the load measurement until the necessary number of CPUs capable of performing the analysis is secured.

4. A parallel computer which comprises a master device and a plurality of slave devices, and performs predetermined analysis processing by adopting an area division method of dividing an area as an object for analysis into areas and assigning the areas to the slave devices, and by passing boundary data between the slave devices to which adjacent areas are assigned for analysis,
the master device including
a unit for transmitting an initial value necessary to perform the analysis processing to all the slave devices;
a unit for receiving notification information indicating termination of the analysis processing from all the slave devices; and
a unit for controlling processing, and
each of the slave devices including
a unit for receiving the initial value and shifting to a receive stand by status in which the slave device waits for the boundary data from other slave devices which analyze the adjacent areas;
a plurality of CPUs for dividing the assigned are a in to are as to perform analysis calculation on the areas;
a unit for transmitting the boundary data obtained from a result of the calculation to all the slave devices which analyze the adjacent areas;
a unit for receiving the boundary data from all the slave devices which analyze the adjacent areas, performing the analysis calculation again using all the boundary data, and repetitively executing the boundary data passing and analysis calculation until a boundary value of each area is settled; and
a unit for transmitting notification information indicating termination of the analysis processing to the master device when the boundary value of each area has been settled, wherein
the master device finishes all the processing when having received the notification from all the slave devices.

5. An analysis method for performing predetermined analysis processing by adopting an area division method of dividing an area as an object for analysis into areas and assigning the areas to slave devices, and by passing boundary data between the slave devices to which adjacent areas are assigned for analysis, the analysis method comprising steps of:
as processing to be executed by a master device, transmitting an initial value necessary to
perform the analysis processing to all the slave devices; and
receiving notification information indicating termination of the analysis processing from all the slave devices, and
as processing to be executed by the respective slave devices,
shifting to a receive standby status in which the slave device waits for boundary data from other slave devices which analyze the adjacent areas;
performing analysis calculation of the assigned own area;
transmitting the boundary data obtained from a result of the calculation to all the slave devices which analyze the adjacent areas;
receiving the boundary data from all the slave devices which analyze the adjacent areas, performing again the analysis calculation of the own area using all the boundary data, and repetitively executing the boundary data passing and the analysis calculation until a boundary value of each area is settled; and
transmitting the notification information indicating the termination of the analysis processing to the master device when the boundary value of each area has been settled.

6. The analysis method according to claim 5, wherein
the initial value transmission step includes
creating, at the time of initial setting, a transfer partner table used when each slave device directly specifies a communication partner and transfers boundary data to each other, and transmitting the initial value including the table to all the slave devices, and
the boundary data transmission step includes
transmitting the boundary data obtained from the calculation result to all the slave devices which analyze the adjacent areas, based on the table.

7. The analysis method according to claim 5 further comprising steps of:
measuring load of a CPU in each slave device before transmitting the initial value;
determining that the analysis processing is possible when a measurement result is smaller than a predetermined value provided in advance;
determining that the CPU is being used by another user when the measurement result is larger than the predetermined value; and
repetitively executing the load measurement until a necessary number of CPUs capable of performing the analysis is secured.

8. An analysis method for performing predetermined analysis processing by adopting an area division method of dividing an area as an object for analysis into areas and assigning the areas to slave devices, and by passing boundary data between the slave devices to which adjacent areas are assigned for analysis, the analysis method comprising steps of:
as processing to be executed by a master device,
transmitting an initial value necessary to perform the analysis processing to all the slave devices; and
receiving notification information indicating termination of the analysis processing from all the slave devices, and
as processing to be executed by the respective slave devices,
shifting to a receive standby status in which the slave device waits for boundary data from other slave devices which analyze the adjacent areas,
dividing the assigned area into areas to perform analysis calculation on the areas by a plurality of CPUs in the slave device divide;
transmitting the boundary data obtained from a calculation result to all the slave devices which analyze the adjacent areas;
receiving the boundary data from all the slave devices which analyze the adjacent areas, performing again the analysis calculation of the assigned own area using all the boundary data, and repetitively executing the boundary data passing and the analysis calculation until the boundary value of each area is settled; and
transmitting the notification information indicating the termination of the analysis processing to the master device when the boundary value of each area has been settled.

9. A computer program for analysis to be executed by slave devices, the program comprising steps of:
shifting to a receive standby status in which the slave device waits for boundary data from other slave device swhich analyze areas adjacent to each other;
performing analysis calculation of an own area;
transmitting boundary data obtained from a calculation result to all the slave devices which analyze the adjacent areas;
receiving the boundary data from all the slave devices which analyze the adjacent areas, performing again the analysis calculation of the own area using all the boundary data, and repetitively executing boundary data passing and the analysis calculation until a boundary value of each area is settled; and
transmitting notification information indicating termination of the analysis processing to a master device when the boundary value of each area has been settled.
